(19) United States
(12) Patent Application Publication
(10) Pub. No.: US 2008/0049368 A1
(43) Pub. Date: Feb. 28, 2008

(54) Overvoltage protection for a coaxial connector

(75) Inventor: Bruno Ammann, Rorschacherberg (CH)

Correspondence Address: THE WEBB LAW FIRM, P.C., 700 KOPPERS BUILDING, 436 SEVENTH AVENUE, PITTSBURGH, PA, 15219, US

(73) Assignee: HUBERAG, Herisau (CH)

(21) Appl. No.: 11/880,923

(22) Filed: Jul. 25, 2007

(30) Foreign Application Priority Data
Jul. 27, 2006 (CH) 1229/06

(51) Int. Cl. H02H 9/04

(52) U.S. Cl. 361/117; 361/118

(57) ABSTRACT

An overvoltage protection for a coaxial line has a coaxial line section with a first inner conductor which is concentrically surrounded by an outer conductor, with a first branch line in the form of a short-circuit line with a second inner conductor branching off from the coaxial line section in the radial direction, and with the inner conductor being accommodated in a first recess in the outer conductor of the coaxial line section.

### TECHNICAL FIELD

The present invention relates to the field of radio-frequency technology, and in particular to overvoltage protection of a coaxial line according to the precharacterizing clause of claim 1.

Overvoltage protection such as this is known, for example, from DE-A1-195 20 974.

### PRIOR ART

Overvoltage protection apparatuses based on a coaxial design have been used for a long time for protection of electronic circuits in the radio-frequency range against overvoltages which can occur, on the coaxial lines connected to antennas in the event of lightning strikes on those antennas, which overvoltage protection apparatuses act as a bandpass filter for the intended operating frequency, but in contrast have a highly attenuating effect for frequencies which occur in the event of brief overvoltages.

One known type of widely used overvoltage protection is in the form of a coaxial line section with a radially branching λ/4 short-circuit line, as is described by way of example in WO-A1-99/43052.

The radially branching λ/4 short-circuit line in known overvoltage protection such as this is admittedly highly effective in terms of the elimination of overvoltages, but because of the T-shaped geometry associated with it, means that the overvoltage protection is cumbersome and occupies a considerable additional amount of space in the lateral direction, when installed. Various proposals have therefore already been made as to how such overvoltage protection can be considerably reduced in size while maintaining the effective principle, and in particular can be matched to the cylindrical, coaxial geometry, avoiding the T-geometry.

For example, U.S. Pat. No. 6,529,357 has disclosed overvoltage protection in which the λ/4 short-circuit line first of all branches off radially with a short piece of line, but is then arranged with the main part of the line length in a cavity in the outer conductor, on a plane lying parallel to the axis of the coaxial line section. Discrepancies from the cylindrical shape, which occupy additional installation space, result in this case as well.

In another proposal (DE-A1-195 20 974), the main part of the line length of the λ/4 short-circuit line is arranged in an annular area of the outer conductor, concentrically with respect to the axis of the coaxial line section. Although this does not interfere with the cylindrical geometry, this type of arrangement leads to considerably larger external diameters. Furthermore, this results in additional manufacturing effort.

It is also known from WO-A1-02/35659 for two electrically lengthened λ/4 short-circuit lines to be provided instead of a λ/4 short-circuit line, in order to reduce the size of the overvoltage protection and to avoid the normal T-geometry, which lines are connected back-to-back to one another in parallel and are arranged parallel to the inner conductor of the coaxial line section in the interior of the coaxial line section. This admittedly largely maintains the cylindrical geometry, but the axial length of the overvoltage protection is considerable because the two short-circuit lines are arranged one behind the other in the axial direction.

On the other hand, it is known from the field of coaxial lines (U.S. Pat. No. 4,670,724) for a mechanical support, which comprises two supports opposite one another in the radial direction, to be provided in order to support the inner conductor in the surrounding outer conductor in a coaxial line. Each of the two supports of the support pair has a length of less than ⅛ of the mid-frequency of the operating frequency range of the coaxial line. One support is in the form of a short-circuit support, while the opposite, other support is in the form of an open-circuit support. This results in a more compact form than the previously normal two λ/4 supports, without the supports interfering with the transmission response of the line.

### DESCRIPTION OF THE INVENTION

The object of the invention is to provide overvoltage protection for coaxial lines, which operates with branch lines emerging radially from a coaxial line section, and which at the same time is extremely compact and can be produced easily while maintaining the cylindrical shape.

The object is achieved by the totality of features in claim 1. The essence of the invention is to provide two electrically shorter branch lines, which branch off on different sides, for suppression of the overvoltages instead of one λ/4 short-circuit line, the first of which branch lines is a short-circuit line, and the second is an open-circuit line. The electrical responses of the two branch lines are matched to one another such that their interaction results in the desired suppression of the overvoltages. Both branch lines have an inner conductor, which is in each case accommodated in a recess in the outer conductor of the coaxial line section.

One refinement of the invention, which is particularly preferred because it is extremely compact, is characterized in that the two branch lines are angled and run essentially parallel to the axis of the coaxial line section, in particular with the two branch lines being angled towards the same side in order to achieve short physical lengths.

Another refinement of the invention is distinguished in that the third inner conductor of the second branch line has a first inner conductor section which runs in the radial direction, in that a second inner conductor section is provided which runs in the axial direction, and in that the second inner conductor section is used to match the two branch lines to one another.

In particular, the two inner conductor sections of the third inner conductor of the second branch line are cylindrical, and the second inner conductor section has a considerably larger external diameter than the first inner conductor section.

Another refinement of the invention is characterized in that the second inner conductor of the first branch line is surrounded by air in the first recess of the outer conductor of the coaxial line section, and in that the third inner conductor of the second branch line has an inner conductor section, which is surrounded by a solid dielectric, in the second recess in the outer conductor of the coaxial line section.

The production process is particularly simple if, according to another refinement, the second inner conductor of the first branch line and an inner conductor section of the third inner conductor of the second branch line are formed by a common conductor, which is passed through a transverse aperture hole in the first inner conductor of the coaxial line section.

It is also advantageous for the outer conductor of the coaxial line section to comprise a cylindrical base body and a cylindrical housing, which can be connected, in particular screwed, to one another detachably in order to form the first recess, with the second recess preferably being a blind hole in the base body.

Connections for detachable connection of the coaxial line section to a coaxial line or the like are expediently provided in the axial direction at both ends of the coaxial line section.

One proven refinement of the invention is distinguished in that the overvoltage protection has an impedance of 50Ω, and an operating frequency in the region of about 1 GHz. Other operating frequencies and/or impedances can be produced easily, simply by geometry matching.

### BRIEF EXPLANATION OF THE FIGURES

The invention will be explained in more detail in the following text using exemplary embodiments and in conjunction with the drawing, in which:

FIG. 1 shows a longitudinal section through overvoltage protection according to one preferred exemplary embodiment of the invention;

FIG. 2 shows a perspective view of the base body of the overvoltage protection from FIG. 1;

FIG. 3 shows a Smith diagram of the profile of the (complex) parameter S11 (return loss) of overvoltage protection as shown in FIG. 1, intended for an operating frequency in the region of 1 GHz;

FIG. 4 shows an enlarged detail from FIG. 3;

FIG. 5 shows the magnitude of the parameters S11 and S21 insertion loss) for the overvoltage protection as shown in FIG. 3, as a function of the frequency; and

FIG. 6 shows a simplified equivalent circuit diagram of the overvoltage protection shown in FIG. 1.

### APPROACHES TO IMPLEMENTATION OF THE INVENTION

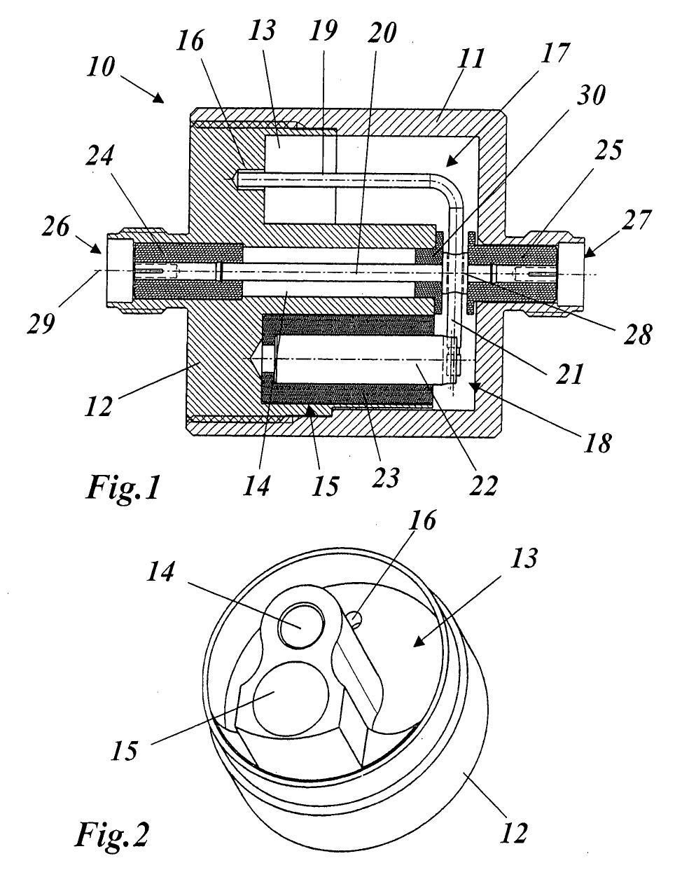

FIG. 1 shows a longitudinal section through overvoltage protection according to one preferred exemplary embodiment of the invention. The illustrated overvoltage protection 10 represents a coaxial line section whose outer conductor, which is arranged between the two coaxial connections 26 and 27, comprises a cylindrical base body 12 and a hollow-cylindrical housing 11, which can be screwed to one another in the axial direction (axis 29) by means of appropriate external and internal threads. The base body 12 and the housing 11 are composed, for example, of brass, and are provided with a surface coating suitable for RF purposes. Axially projecting screw connecting stubs for the connections 26 and 27 are integrally formed on the end surfaces of the two parts 11 and 12.

A concentric aperture hole 14 runs through the base body 12, in which the central area of the inner conductor 20 of the coaxial line section is mounted concentrically by means of appropriate supporting elements 24, 30 composed of insulating material (for example PTFE) at the ends. The inner conductor 20 extends through a corresponding hole in the housing 11, where it is likewise mounted by means of a supporting element 25.

When the base body 12 and the housing 11 are screwed together, a cavity is formed which, inter alia, comprises a recess 13 and a blind hole 15 in the base body 12. A part of the inner conductor 20 with a thicker diameter is exposed between the supporting element 30 and the supporting element 25 in the right-hand area of the cavity, through which an aperture hole 28 runs transversely with respect to the axis direction. A conductor 19, 21 is passed through the aperture hole 28, is bent at right angles on one side, and then runs parallel to the axis to the base of the recess 13 in the base body 12 (inner conductor 19), where its end is soldered into a blind hole 16 in the base body 12. At the other end, the conductor ends (as the inner conductor section 21) in the radial orientation, and its end is firmly soldered to the upper end of a cylindrical piece of line (inner conductor section 22), which is likewise oriented parallel to the axis and, insulated by a solid dielectric 23, is arranged concentrically in the blind hole 15. By way of example, the dielectric 23 may also be formed from PTFE.

The inner conductor 19 is part of a first branch line 17, which branches radially from the coaxial line section and runs parallel to the axis over the majority of its length. The first branch line is a short-circuit line, with the inner conductor 19 mounted together with the base body 12 and the housing 11 as the outer conductor, forming an air line. Its electrical length is considerably less than λ/4 and may, for example, be in the region of λ/8.

The inner conductor sections 21 and 22 are part of a second branch line 18 which likewise branches radially off the coaxial line section—in the opposite direction to the first branch line 17—and runs parallel to the axis over the majority of its length (inner conductor section 22). The second branch line 18 is an open line or open-circuit line, with the inner conductor (inner conductor section 22) being isolated from the outer conductor (base body 12) by means of a dielectric 23 instead of air. Its electrical length is likewise considerably less than λ/4, and may also be in the region of λ/8.

In the equivalent circuit shown in FIG. 6, the first branch line 17 forms a parallel circuit comprising an inductance and a capacitance. The second branch line 18 forms a series circuit comprising an inductance and a capacitance. The branch line 18 can be matched to the branch line 17 by suitable choice of the dimensions (for example diameter) of the inner conductor section 22 and of the dielectric 23.

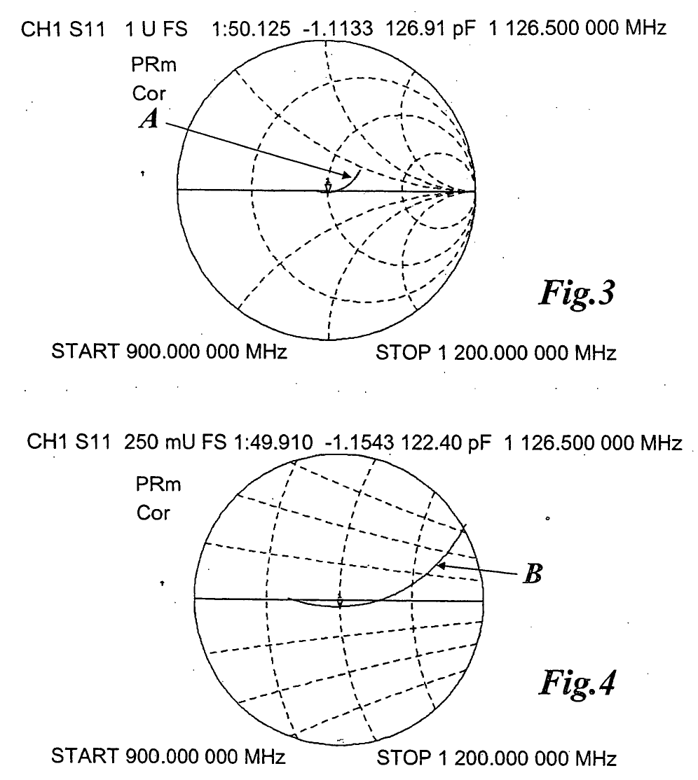

The operation of the two branch lines 17, 18 can be explained as follows: In the Smith diagram shown in FIG. 3 or 4, an ideally matched 50Ω line is located at the centre point. A short circuit is located on the circle edge on the left, while the open circuit is located on the right. Both the short circuit and the open circuit now rotate in the clockwise direction on the circle as the length increases. A half revolution (180°) is achieved with a length of λ/4. A 90° rotation to the position +j50 Ohm or −j50 Ohm is achieved for a length of λ/8. By variation of the mechanical length of the short-circuit line (17), it is possible, for example, for the short circuit to be rotated through only 45°. In order now to compensate for this short circuit, the open-circuit line (18) must be made correspondingly longer. This can be done by effective mechanical extension, by variation of the impedance, or by a combination of both measures. In the present case (FIG. 1), the impedance is massively reduced (diameter enlargement of the inner conductor section 22), and the mechanical length is matched approximately to the mechanical length of the short circuit. Angling of the two branch lines makes it possible to once again reduce the size of the structure, while completely maintaining the cylindrical geometry.

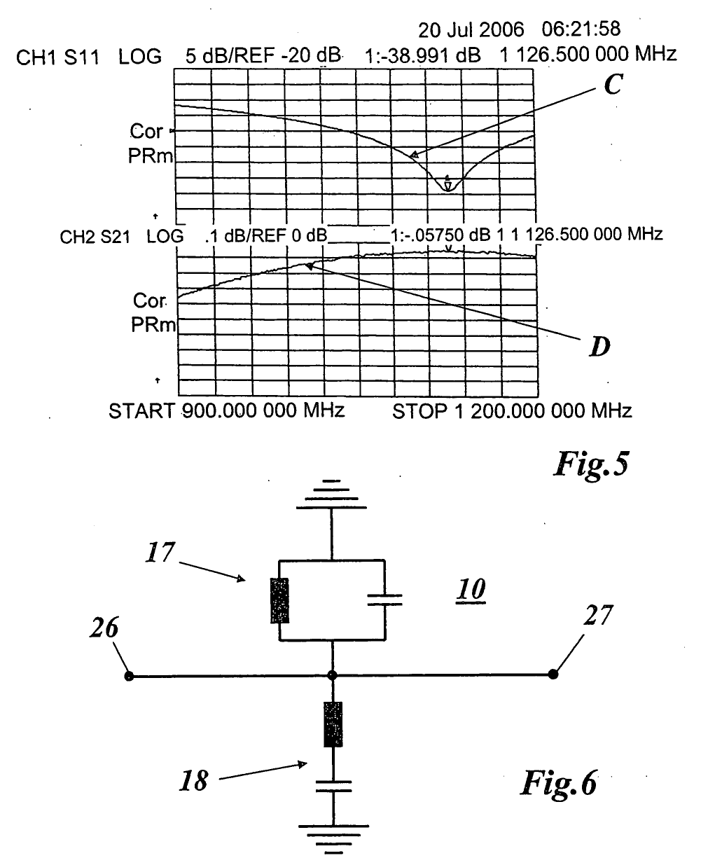

Overvoltage protection 10, which is constructed for the purposes of the invention according to the exemplary embodiment shown in FIG. 1, has a length including the connections 26 and 27 of about 36 mm, and an external diameter of about 24 mm, for an impedance of 50Ω and a frequency range from 1.02 to 1.09 GHz. As shown in FIG. 5, the return loss (S11; curve C in FIG. 5) ≧20 dB, and the insertion loss (S21, curve D in FIG. 5) ≦0.1 dB. The complex return loss S11 has the profile illustrated by the curves A and B in FIGS. 3 and 4 in the frequency range between 900 MHz and 1200 MHz. In addition to the compact structure and the very small external dimensions, overvoltage protection such as this is also very light in weight, in the region of about 60 g.

### LIST OF REFERENCE SYMBOLS

10 Overvoltage protection
11 Housing (hollow cylindrical)
12 Base body
13 Recess
14 Through-hole (central)
15,16 Blind hole
17,18 Branch line
19 Inner conductor (branch line 17)
20 Inner conductor (continuous)
21,22 Inner conductor section (branch line 18)
23 Dielectric
24,25,30 Supporting element
26,27 Connection
28 Aperture hole
29 Axis
A,B,C,D Curve

1-11. (canceled)

12. An overvoltage protection for a coaxial line having a coaxial line section with a first inner conductor which is concentrically surrounded by an outer conductor, the overvoltage protection comprising:
a first branch line in the form of a short-circuit line with a second inner conductor branching off from the coaxial line section in the radial direction, and with the inner conductor being accommodated in a first recess in the outer conductor of the coaxial line section;
a second branch line branching off from the coaxial line section in the radial direction opposite the first branch line, wherein:
the second branch line is in the form of an open-circuit line and has a third inner conductor which is accommodated in a second recess in the outer conductor of the coaxial line section;
the two branch lines each have a length less than one-fourth of the wavelength at the operating frequency of the overvoltage protection; and
the two branch lines are matched to one another.

13. The overvoltage protection of claim 12, wherein the two branch lines are angled, and run essentially parallel to the axis of the coaxial line section.

14. The overvoltage protection of claim 13, wherein the two branch lines are angled towards the same side.

15. The overvoltage protection of claim 12, wherein the third inner conductor of the second branch line has a first inner conductor section which runs in the radial direction, and a second inner conductor which runs in the axial direction, wherein the second inner conductor section is used to match the two branch lines to one another.

16. The overvoltage protection of claim 15, wherein the two inner conductor sections of the third inner conductor of the second branch line are cylindrical, and the second inner conductor section has a larger external diameter than the first inner conductor section.

17. The overvoltage protection of claim 12, wherein the second inner conductor of the first branch line is surrounded by air in the first recess in the outer conductor of the coaxial line section, and the third inner conductor of the second branch line has an inner conductor section in the second recess in the outer conductor of the coaxial line section, which inner conductor section is surrounded by a solid dielectric.

18. The overvoltage protection of claim 12, wherein the second inner conductor of the first branch line and an inner conductor section of the third inner conductor of the second branch line are formed by a common conductor which is passed through a transverse aperture hole in the first inner conductor of the coaxial line section.

19. The overvoltage protection of claim 12, wherein the outer conductor of the coaxial line section comprises a cylindrical base body and a cylindrical housing which can be coupled to one another detachably in order to form the first recess.

20. The overvoltage protection of claim 19, wherein the second recess is in the form of a blind hole in the base body.

21. The overvoltage protection of claim 12, wherein connections for detachable connection of the coaxial line section to a coaxial line or the like are provided in the axial direction of both ends of the coaxial line section.

22. The overvoltage protection of claim 12, wherein the overvoltage protection has an impedance of 50Ω and an operating frequency in the region of about 1 GHz.
